(19) United States
(12) Patent Application Publication
(10) Pub. No.: US 2015/0252751 A1
(43) Pub. Date: Sep. 10, 2015

(54) GEARED GAS TURBINE ENGINE INTEGRATED WITH A VARIABLE AREA FAN NOZZLE WITH REDUCED NOISE

(71) Applicant: UNITED TECHNOLOGIES CORPORATION, Hartford,, CT (US)

(72) Inventor: Constantine Baltas, Manchester, CT (US)

(21) Appl. No.: 14/430,952

(22) PCT Filed: Mar. 1, 2013
(86) PCT No.: PCT/US2013/028526

§ 371 Date: Mar. 25, 2015

Related U.S. Application Data
(60) Provisional application No. 61/706,324, filed on Sep. 27, 2012.

(51) Int. Cl. F02K 1/06; F02C 7/24; F02C 3/04

(52) U.S. Cl. CPC F02K 1/06; F02C 3/04; F02C 7/24

(57) ABSTRACT

A gas turbine engine includes a spool and a turbine coupled to drive the spool. A fan is coupled to be driven by the turbine through the spool. A gear assembly is coupled between the fan and the spool such that rotation of the spool drives the fan at a different speed than the spool. A fan nozzle is located downstream from the fan. The fan nozzle includes a variable area nozzle configured to change an exit area of the fan nozzle. An acoustic liner partially lines the fan nozzle.

### CROSS REFERENCE TO RELATED APPLICATION

This application claims priority to U.S. Provisional Application No. 61/706,324, which was filed 27 Sep. 2012 and is incorporated herein by reference.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Turbine engine manufacturers continue to seek further improvements to engine performance and reductions in noise.

### SUMMARY

A gas turbine engine according to an exemplary aspect of the present disclosure includes a spool, a turbine coupled to drive the spool, a fan coupled to be driven by the turbine through the spool, a gear assembly coupled between the fan and the spool such that rotation of the spool drives the fan at a different speed than the spool and a fan nozzle downstream from the fan. The fan nozzle includes a variable area nozzle configured to change an exit area of the fan nozzle, and an acoustic liner partially lining the fan nozzle.

In a further non-limiting embodiment of any of the foregoing examples, the acoustic liner is perforated.

In a further non-limiting embodiment of any of the foregoing examples, the acoustic liner includes a honeycomb between two face sheets, and one of the face sheets that faces into a bypass flow path of the fan nozzle is perforated.

In a further non-limiting embodiment of any of the foregoing examples, the acoustic liner lines no greater than 50% of a surface area of a bypass passage of the fan nozzle.

In a further non-limiting embodiment of any of the foregoing examples, the acoustic liner is perforated and lines no greater than 50% of a surface area of a bypass passage of the fan nozzle.

In a further non-limiting embodiment of any of the foregoing examples, the fan nozzle includes a fan bypass duct having an outer wall, an inner wall and a fan bypass passage there between.

In a further non-limiting embodiment of any of the foregoing examples, the fan has a design pressure ratio of approximately 1.25-1.6.

In a further non-limiting embodiment of any of the foregoing examples, the fan has a design pressure ratio of 1.25-1.6.

In a further non-limiting embodiment of any of the foregoing examples, the fan has a design pressure ratio of 1.25-1.6, and the acoustic liner is perforated and lines no greater than 50% of a surface area of a bypass passage of the fan nozzle.

A fan nozzle according to an exemplary aspect of the present disclosure includes a fan bypass duct that has an outer wall, an inner wall and a fan bypass passage there between. The fan bypass duct defines an exit area and is configured to adjust the exit area. An acoustic liner partially lines the fan bypass duct.

In a further non-limiting embodiment of any of the foregoing examples, the acoustic liner is perforated.

In a further non-limiting embodiment of any of the foregoing examples, the acoustic liner includes a honeycomb between two face sheets, and one of the face sheets is perforated and faces into the fan bypass passage.

In a further non-limiting embodiment of any of the foregoing examples, the acoustic liner lines no greater than 50% of a surface area of the fan bypass passage.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates selected portion of another example gas turbine engine.

FIG. 3 illustrates an example perforated acoustic liner.

### DESCRIPTION

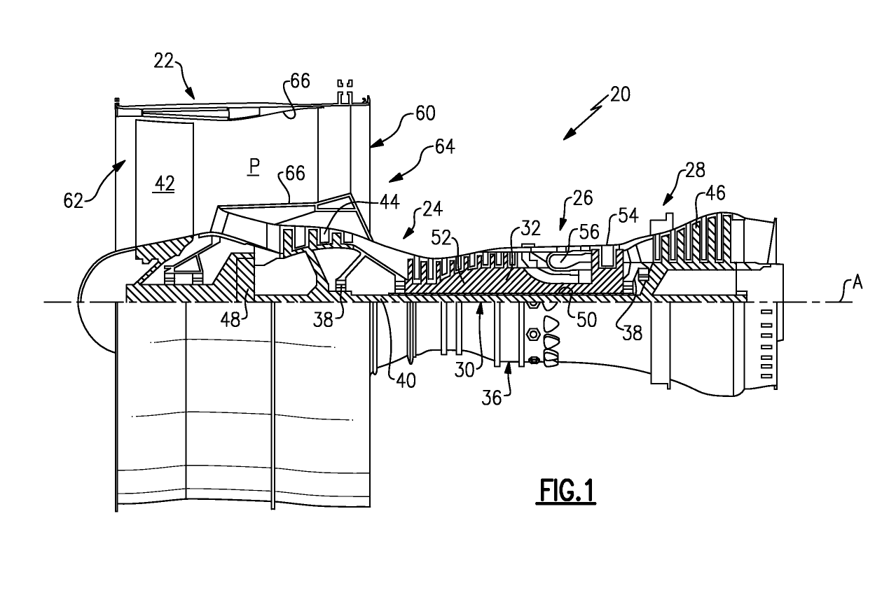

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The compressor section 24, combustor section 26 and turbine section 28 are part of a core engine that drives the fan section 22. Alternative engines might include an augmentor section (not shown) among other systems or features. The fan section 22 drives air along a bypass flow path P, also known as a fan bypass duct, while the compressor section 24 drives air along a core flow path for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines, including single spool or three-spool architectures.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

The core airflow is compressed by the first compressor 44 then the second compressor 52, mixed and burned with fuel in the annular combustor 56, then expanded over the second turbine 54 and first turbine 46. The first turbine 46 and the second turbine 54 rotationally drive, respectively, the first spool 30 and the second spool 32 in response to the expansion.

The engine 20 is a high-bypass geared aircraft engine that has a bypass ratio that is greater than about six (6), with an example embodiment being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about five (5). The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption ('TSFC')”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]⁰⁵. The “Low corrected fan tip speed” as disclosed herein according to one non-limiting embodiment is less than about 1150 ft/second.

The engine 20 can include a variable area fan nozzle 60 (hereafter “VAFN 60”) that is operable to change an exit area of the fan bypass flow path P. For example, the VAFN 60 can include flaps that are moveable using one or more actuator mechanisms between open, closed and intermediate positions. As can be appreciated, other mechanisms or configurations can alternatively be used.

In one example, the engine 20 and fan 42 are configured to operate at a fan design pressure ratio of approximately 1.25-1.6, which generates relatively low fan noise and low jet noise. The use of the fan drive gear system 48 and VAFN 60 enables the noise reduction.

The design pressure ratio is with respect to an inlet pressure at an inlet 62 and an outlet pressure at an outlet 64 of the fan bypass flow path P. As an example, the design pressure ratio may be determined based upon the stagnation inlet pressure and the stagnation outlet pressure at a design rotational speed of the engine 20. The VAFN 60 is operative to change the exit area of the outlet 64 to thereby control the pressure ratio via changing pressure within the fan bypass flow path P. The design pressure ratio may be defined with the VAFN 60 fully open or fully closed.

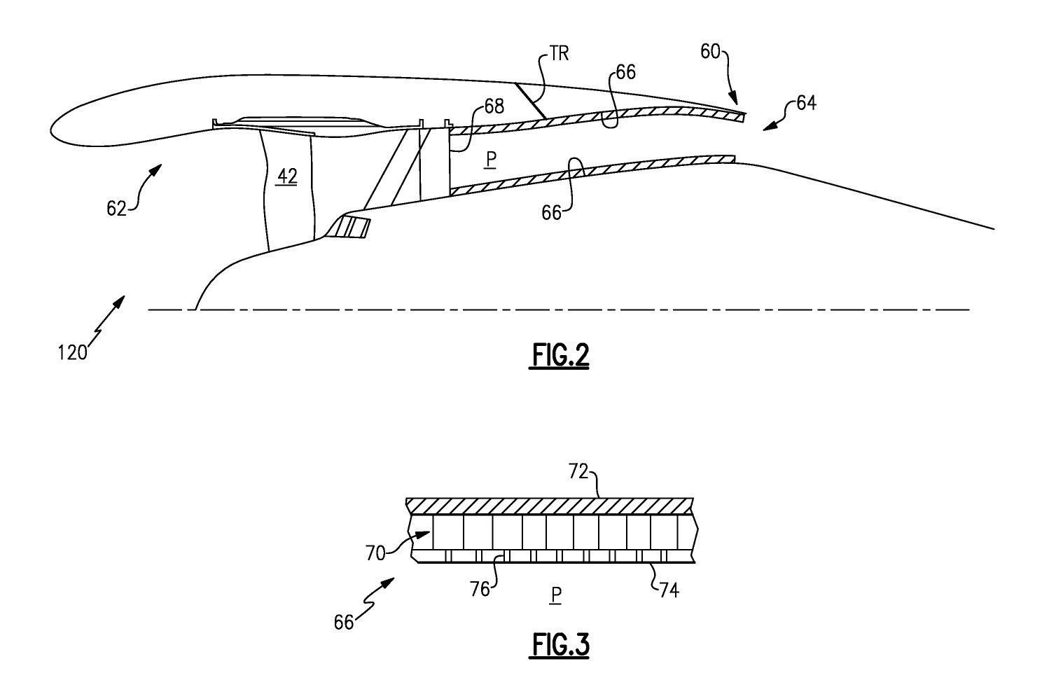

The reduction in noise generation reduces the need for acoustic attenuation. For example, FIG. 2 illustrates another example engine 120 that is similar to the engine 20 of FIG. 1. FIG. 2 does not show the core engine sections, which are similar to the engine 20 of FIG. 1 as described above.

The engine 120 includes an acoustic liner 66 located on an outer fixed area and inner fixed area of the fan bypass flow path P, to attenuate noise. For example, the outer fixed area is an outer case/wall that bounds an outer diameter of the fan bypass flow path P and the inner fixed area is an inner case/wall or core cowl that bounds an inner diameter of the fan bypass flow path P.

In a further example, the acoustic liner 66 is located aft of engine exit guide vanes 68 and may or may not cover or partially cover areas of a thrust reverser, TR, in the fan bypass flow path P. In one example shown in FIG. 3, the acoustic liner 66 is a perforated structure that includes a honeycomb 70 between two face sheets 72/74, where at least the face sheet 74 that bounds the fan bypass flow path P has perforations 76.

The reduction in noise by the use of the given pressure ratio, fan drive gear system 48 and VAFN 60 permits a reduction in the area covered by the acoustic liner 66. In one example, compared to a similar engine without the VAFN 60 and fan drive gear system 48, the engine 20 produces the same or less noise using 50% or less area of the acoustic liner 66. In a further example, up to 60% of the surfaces of the VAFN 60 that bound the fan bypass flow path P include, i.e., cover, the acoustic liner 66.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gas turbine engine comprising:
a spool;
a turbine coupled to drive the spool;
a fan coupled to be driven by the turbine through the spool;
a gear assembly coupled between the fan and the spool such that rotation of the spool drives the fan at a different speed than the spool;
a fan nozzle downstream from the fan, the fan nozzle including a variable area nozzle configured to change an exit area of the fan nozzle; and
an acoustic liner partially lining the fan nozzle.

2. The gas turbine engine as recited in claim 1, wherein the acoustic liner is perforated.

3. The gas turbine engine as recited in claim 1, wherein the acoustic liner includes a honeycomb between two face sheets, and one of the face sheets that faces into a bypass flow path of the fan nozzle is perforated.

4. The gas turbine engine as recited in claim 1, wherein the acoustic liner lines no greater than 50% of a surface area of a bypass passage of the fan nozzle.

5. The gas turbine engine as recited in claim 1, wherein the acoustic liner is perforated and lines no greater than 50% of a surface area of a bypass passage of the fan nozzle.

6. The gas turbine engine as recited in claim 1, wherein the fan nozzle includes a fan bypass duct having an outer wall, an inner wall and a fan bypass passage there between.

7. The gas turbine engine as recited in claim 1, wherein the fan has a design pressure ratio of approximately 1.25-1.6.

8. The gas turbine engine as recited in claim 1, wherein the fan has a design pressure ratio of 1.25-1.6.

9. The gas turbine engine as recited in claim 1, wherein the fan has a design pressure ratio of 1.25-1.6, and the acoustic liner is perforated and lines no greater than 50% of a surface area of a bypass passage of the fan nozzle.

10. A fan nozzle comprising:
a fan bypass duct including an outer wall, an inner wall and a fan bypass passage there between, the fan bypass duct defining an exit area and being configured to adjust the exit area; and
an acoustic liner partially lining the fan bypass duct.

11. The fan nozzle as recited in claim 10, wherein the acoustic liner is perforated.

12. The fan nozzle as recited in claim 10, wherein the acoustic liner includes a honeycomb between two face sheets, and one of the face sheets is perforated and faces into the fan bypass passage.

13. The gas turbine engine as recited in claim 1, wherein the acoustic liner lines no greater than 50% of a surface area of the fan bypass passage.
